(19) United States
(12) Patent Application Publication
(10) Pub. No.: US 2019/0050773 A1
(43) Pub. Date: Feb. 14, 2019

(54) PRODUCTION FACILITY INVESTMENT PLANNING ASSISTANCE SYSTEM AND COMMODITY PRODUCTION SYSTEM

(71) Applicant: HONDA MOTOR CO., LTD., Minato-ku, Tokyo (JP)

(72) Inventor: Naoi Watanabe, Minato-ku, Tokyo (JP)

(21) Appl. No.: 16/076,333

(22) PCT Filed: Dec. 27, 2016
(86) PCT No.: PCT/JP2016/088968

§ 371 Date: Aug. 8, 2018

(30) Foreign Application Priority Data
Feb. 12, 2016 (JP) 2016-025161

(51) Int. Cl. G06Q 10/06; G06Q 10/08; G06Q 40/04; G06Q 50/04

(52) U.S. Cl. CPC G06Q 10/06315; G06Q 10/06314; G06Q 50/04; G06Q 10/083; G06Q 40/04; G06Q 10/06375

(57) ABSTRACT

A production facility investment planning assistance system has: a database in which various data are registered; a scheduler for performing scheduling while taking into account at least constraints of a date and work in progress in a plurality of factories, as well as the maximum number of manufacturing processes, unit costs, etc., per unit period in each factory; a lead time calculation unit for calculating a necessary lead time; a date-setting unit for removing the constraints of the date and setting at least one of a drawing release date and a production facility introduction deadline as a new date that is a day within a prescribed range and that precedes the date or follows the date; and an investment cost prediction unit for predicting production facility investment costs on the basis of at least the set new date.

### TECHNICAL FIELD

The present invention relates to a production facility investment planning assistance system that assists planning and drafting of the cost of an investment in a production facility (such as a mold) that is used in production (manufacturing) of a future product or a component (a workpiece) and also relates to a commodity production system that assists planning and drafting of the investment cost in a commodity that is used to manufacture a future commodity.

### BACKGROUND ART

As a method of determining a production schedule of a production facility such as a mold, there is a method described in Japanese Patent No. 4528425, for instance.

This method determines a processing schedule by dividing it into a long-term schedule (from a few months before the start of processing to a few weeks before the start of processing) and a short-term schedule (from a time immediately before the start of processing to a few weeks before the start of processing), which include instruction information on operation processes of manufacturing the mold, based on external information including model plan information, information on release of a drawing, material arrival information, externally-manufactured article arrival information, and components arrival information. In particular, in the course of determination of a long-term schedule, a plan in accordance with working capacity is made for each level of hierarchy; in the course of determination of a short-term schedule, an operation allocation plan is made.

### SUMMARY OF INVENTION

It is understood that manufacturing of a production facility such as a mold begins after a drawing for the mass production of a product or a component thereof is finalized. Therefore, when a production schedule of a production facility is drafted by using, for example, the schedule determination method described in Japanese Patent No. 4528425, the production schedule is set based on a time period from a date of release of a drawing (drawing-release date) to a deadline for introduction of the production facility. That is, as depicted in FIG. 15, a manufacturing period of the production facility is concentrated on a period from the drawing-release date to the deadline for introduction of the production facility.

Given the investment cost related to manufacturing of a production facility, however, it is possible to reduce the investment cost by manufacturing the production facility in a lowest-cost production facility plant. However, if the production capacity of the lowest-cost plant, in particular the production capacity thereof at the time of order, is small, a plant other than the lowest-cost plant has to be used, whereby the effect of the reduced investment cost may be lessened.

As described above, although schedule management of a production facility in a given time period is certainly important, a reduction in the investment cost of the production facility is also an important factor. Especially when production bases of the production facility are located at home and abroad, wage rates, material costs, and energy costs including electricity vary from country to country and in addition, land prices and depreciation on a manufacturing apparatus vary from base to base. Moreover, it is also necessary to consider the cost of transportation or the number of days required for transportation between a country where the production facility is used and a country where a base that manufactures the production facility is located and also to consider exchange-rate fluctuations.

The present invention has been made in view of such problems and an object thereof is to provide a production facility investment planning assistance system that can easily propose a schedule that can achieve the lowest cost in planning and drafting the investment cost of a production facility that is used to produce (manufacture) a future product or a component (a workpiece).

Moreover, another object of the present invention is to provide a commodity production system that can easily propose a schedule that can achieve the lowest cost in planning and drafting the investment cost of a commodity that is produced in a production base.

[1] A production facility investment planning assistance system according to a first aspect of the present invention is a production facility investment planning assistance system that assists planning and drafting of the investment cost of a production facility that is used in production of a future product or a component thereof. The production facility investment planning assistance system includes: a database to which date restrictions including at least a date of release of a drawing of the product or the component thereof and a deadline for introduction of the production facility and a date of start of mass production of the product and the part thereof are input; a unit that gives consideration to at least the date restrictions and in-process production facilities in each of a plurality of production facility manufacturing plants that manufacture the production facility and the maximum number of production facilities that can be manufactured per unit period in each production facility manufacturing plant; a unit that calculates at least a necessary lead time from a plurality of pieces of data related to the plurality of production facility manufacturing plants; a unit that lifts at least the date restrictions and setting, for at least one of the date of release of a drawing and the deadline for introduction of the production facility, a date which is within a desired range and is a date before or after the above date as a new date; and a unit that predicts the investment cost of the production facility based on at least the new date thus set.

This makes it possible to propose a schedule that can achieve the lowest investment cost for the production facility such as a mold.

For example, it is possible to easily propose a schedule that can achieve the lowest cost by setting a date before the drawing-release date registered in the database as a new drawing-release date by, for example, setting a date before the drawing-release date as a candidate date for release of a drawing, calculating the investment cost from the candidate date for a drawing-release date to the deadline for introduction of the production facility, and setting the candidate date at which the calculated investment cost is the lowest, as the drawing-release date.

Moreover, this produces the effect of making it possible to easily propose a schedule that can achieve the lowest cost by setting a date before the deadline for introduction of the production facility that is registered in the database as a new deadline for introduction by, for example, setting a date before the deadline for introduction of the production facility as a candidate date for a new deadline for introduction, calculating the investment cost from the drawing-release date to the candidate date (a deadline for introduction of the production facility), and setting the candidate date at which the calculated investment cost is the lowest, as the deadline for introduction of the production facility.

[2] In the first aspect of the present invention, it is preferable that the production facility investment planning assistance system includes a display that displays the investment cost of the production facility. As a result of the production facility investment planning assistance system being provided with the display that displays the investment cost of the production facility, it is possible to propose a schedule that can achieve the lowest investment cost for the production facility.

[3] In the first aspect of the present invention, the production facility investment planning assistance system may stop giving consideration to the maximum number of production facilities that can be manufactured in each production facility manufacturing plant while lifting the date restrictions, and predict the investment cost of the production facility by distributing the total number of necessary actions for the production facility to a production facility manufacturing plant that can manufacture the production facility at the lowest cost, from among the plurality of production facility manufacturing plants.

This makes it possible easily to recognize the candidate date for a drawing-release date at which the cost is the lowest, the investment cost, and the required capacity. In addition thereto, it also becomes possible to make a proposal concerning the future capacity of manufacturing in the lowest-cost plant.

[4] In the first aspect of the present invention, the production facility investment planning assistance system may display the lowest investment cost when predicting the investment cost of the production facility. That is, by lifting the date restrictions, it is possible to display, including a date other than the restricted date, a candidate date for a drawing-release date at which the investment cost is the lowest, the lowest investment cost, and so forth.

[5] In the first aspect of the present invention, the production facility investment planning assistance system may display the lowest required capacity when predicting the investment cost of the production facility. That is, by lifting the date restrictions, it is possible to display, including a date other than the restricted date, a candidate date for a drawing-release date at which the required capacity is the lowest, the lowest required capacity, and so forth.

[6] In this case, the lowest required capacity may be displayed using a graph with different colors. This makes it possible to recognize the candidate date for a drawing-release date at which the required capacity is the lowest, the lowest required capacity, and so forth with ease.

[7] In the first aspect of the present invention, the production facility investment planning assistance system may display the lowest investment cost and the lowest required capacity when predicting the investment cost of the production facility. That is, by lifting the date restrictions, it is possible to display, including a date other than the restricted date, a candidate date for a drawing-release date at which the investment cost is the lowest and the required capacity is the lowest, the lowest investment cost, the lowest required capacity, and so forth.

[8] In this case, the lowest investment cost and the lowest required capacity may be displayed using a graph with different colors. This makes it possible to recognize the candidate date for a drawing-release date at which the investment cost is the lowest and the required capacity is the lowest, the lowest investment cost, the lowest required capacity, and so forth with ease.

[9] In the first aspect of the present invention, the production facility investment planning assistance system may display at least the predicted investment cost in local currency of an investing country. This makes it possible to coordinate schedules or the like smoothly with a person in charge in the investing country.

[10] In the first aspect of the present invention, the plurality of pieces of data on the production facility manufacturing plants may include the number of days required for transportation and the cost of transportation between a country where each production facility manufacturing plant is located and a country where a customer that uses the production facility is located, and the unit that calculates the lead time may calculate the necessary lead time, including the cost of transportation and the number of days required for transportation. This makes it possible to propose a schedule that can achieve the lowest investment cost for the production facility such as a mold, including not only a domestic production facility manufacturing plant, but also a foreign production facility manufacturing plant. The cost of transportation may include customs.

[11] In the first aspect of the present invention, the plurality of pieces of data on the production facility manufacturing plants may include a country where each production facility manufacturing plant is located and the exchange rate of a local currency of the country to an investment base currency, and the unit of predicting the investment cost of the production facility may predict the investment cost of the production facility, including the exchange rate. Also in this case, it is possible to propose a schedule that can achieve the lowest investment cost for the production facility such as a mold, including not only a domestic production facility manufacturing plant, but also a foreign production facility manufacturing plant.

[12] A commodity production system according to a second aspect of the present invention is a commodity production system that performs production planning of a commodity. The commodity production system includes: a database to which date restrictions including at least a scheduled date of confirmation of order specifications of the commodity and a date of delivery of the commodity are input; a unit that gives consideration to at least the date restrictions and goods in process and an inventory of the commodity in each of a plurality of production bases that produce the commodity and the maximum number of commodities that can be produced per unit period in each production base; a unit that calculates at least the number of actions and a necessary lead time from a plurality of pieces of data related to the production bases; a unit that lifts at least the date restrictions and setting, for at least one of the scheduled date of confirmation of order specifications and the date of delivery, a date that is within a desired range and is a date before or after the above date as a new date; and a unit that predicts the production cost of the commodity based on at least the new date thus set.

This makes it possible to propose a schedule that can achieve the lowest investment cost for the commodity.

With the production facility investment planning assistance system according to the present invention, it is possible to easily propose a schedule that can achieve the lowest cost in planning and drafting the investment cost of a production facility (such as a mold) that is used in production (manufacturing) of a future product or a part (a workpiece).

With the commodity production system according to the present invention, it is possible to easily propose a schedule that can achieve the lowest cost in planning and drafting the investment cost of a commodity that is produced in a production base.

### BRIEF DESCRIPTION OF DRAWINGS

FIG. 1 is a block diagram depicting a production facility investment planning assistance system according to the present embodiment;

FIG. 2 is a block diagram depicting a production facility investment planning assistance system (a first assistance system) according to a first specific example;

FIG. 3 is a flowchart (I) showing a processing operation of the first assistance system;

FIG. 4 is a flowchart (II) showing the processing operation of the first assistance system;

FIG. 5 is an explanatory diagram depicting a display mode of the first assistance system;

FIG. 6 is a block diagram depicting a production facility investment planning assistance system (a second assistance system) according to a second specific example;

FIG. 7 is a flowchart (I) showing a processing operation of the second assistance system;

FIG. 8 is a flowchart (II) showing the processing operation of the second assistance system;

FIG. 9 is an explanatory diagram depicting a display mode of the second assistance system;

FIG. 10 is a block diagram depicting a production facility investment planning assistance system (a third assistance system) according to a third specific example;

FIG. 11 is a flowchart (I) showing a processing operation of the third assistance system;

FIG. 12 is a flowchart (II) showing the processing operation of the third assistance system;

FIGS. 13A and 13B are explanatory diagrams depicting a display mode of the third assistance system;

FIG. 14 is a block diagram depicting a commodity production system according to the present embodiment; and

FIG. 15 is a graph showing an example of fluctuations in the investment cost during a manufacturing period of a production facility in an existing example.

### DESCRIPTION OF EMBODIMENTS

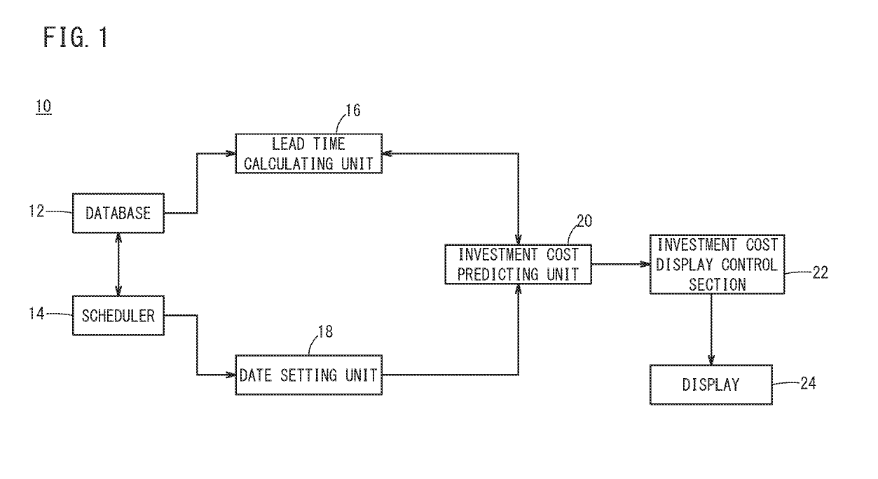

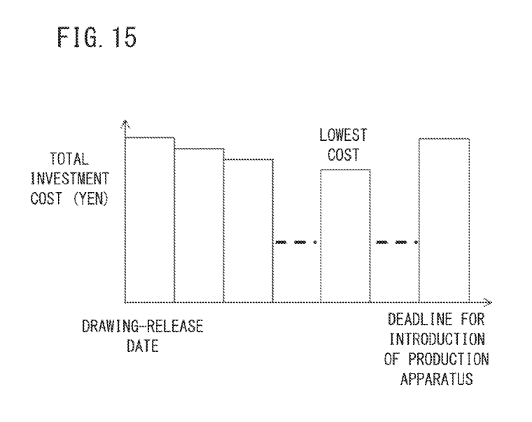

Hereinafter, embodiment examples of a production facility investment planning assistance system and a commodity production system according to the present invention will be described with reference to FIGS. 1 to 15.

A production facility investment planning assistance system 10 according to the present embodiment includes, as depicted in FIG. 1, a database 12, a scheduler 14, a lead time calculating unit 16, a date setting unit 18, an investment cost predicting unit 20, and an investment cost display control section 22.

Various kinds of data are registered in the database 12 via a network or through an input device such as a keyboard. In particular, date restrictions (restrictions concerning a date) are input thereto. The date restrictions includes a date of release of a drawing (drawing-release date) for a future product or a component (a workpiece) thereof, a deadline for introduction of a production facility (for example, a mold), and a date of the start of mass production of the product and the component thereof.

In the database 12, in addition to the above-described data, various kinds of data about a plurality of production facility manufacturing plants are registered. Examples of the various kinds of data are as follows:

(a) The cost of transportation (including customs) between each of the countries where the production facility manufacturing plants are located and a country where a customer (a maker who uses the mold) is located;

(b) The number of days required for transportation; and

(c) Fluctuations in the foreign exchange rate (rate: unit local currency=xxx yen) of local currency to Japanese yen if the country where the production facility manufacturing plant is located is not Japan.

Although (a) and (b) of (a) to (c) change little, (c) changes every day; therefore, (c) may be updated at predetermined time intervals or may be set at a predicted rate based on the fluctuations in the past several months, for example. It is understood that the average rate of the past several months may be adopted.

The scheduler 14 may be installed in each of the plurality of production facility manufacturing plants that manufacture production facilities, or the scheduler 14 may be installed in a country that serves as a hub of the countries where these production facility manufacturing plants are located and may transmit a schedule to the plurality of production facility manufacturing plants via the network. In particular, this scheduler 14 performs scheduling taking account of at least the date restrictions, in-process production facilities of each of the production facilities in the plurality of production facility manufacturing plants that manufacture the production facilities, the maximum number of production facilities that can be manufactured per unit period and the unit cost (cost/the number of pieces) of the production facility in each production facility manufacturing plant, and the like. If the scheduler 14 is installed in each of the plurality of production facility manufacturing plants, the above-described in-process production facilities, maximum number of production facilities that can be manufactured per unit period, and the like are registered in the database 12 via the network. As the scheduler 14, a scheduler described in Japanese Patent No. 4528425, for example, can be used.

The lead time calculating unit 16 calculates at least a necessary lead time from a plurality of pieces of data (such as the maximum number of production facilities that can be manufactured per unit period) related to the plurality of production facility manufacturing plants. In addition to the lead time, the lead time calculating unit 16 may calculate the number of actions.

The date setting unit 18 accepts lifting of the date restrictions through, for example, an input device such as an unillustrated keyboard or a touch panel of a display 24, lifts at least the date restrictions, and sets, for at least one of the drawing-release date and the deadline for introduction of the production facility, a date that is within a desired range (within two months before and after the above date, for example) and is a date before or after the above date as a new date. The desired range may be set in advance.

The investment cost predicting unit 20 predicts the investment cost of the production facility based on the new date thus set.

The investment cost display control section 22 displays, for example, the investment cost predicted for each of the new dates on the display 24.

This makes it possible to propose a schedule that can achieve the lowest investment cost for the production facility.

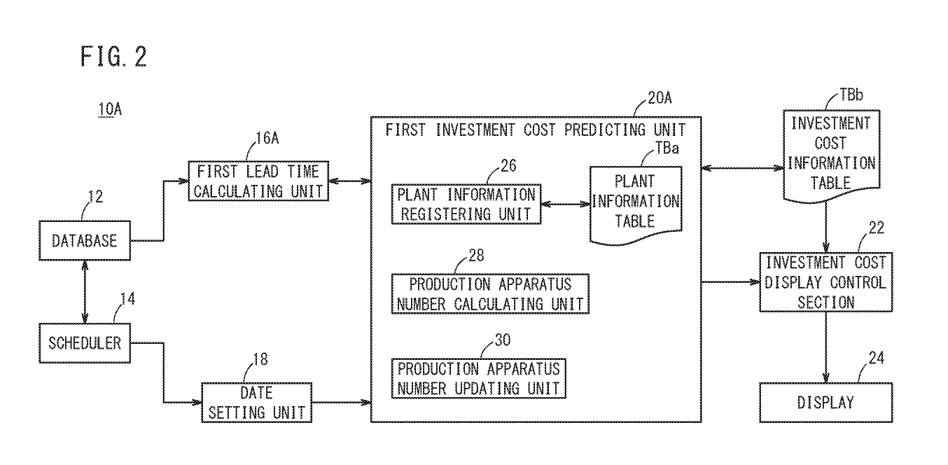

Here, some specific configuration examples of the production facility investment planning assistance system 10 will be described with reference to FIGS. 2 to 13B.

First, in the production facility investment planning assistance system (hereinafter written as a first assistance system 10A) according to a first specific example, the date setting unit 18 lifts the date restrictions by making a person input lifting of the date restrictions through, for instance, the input device such as an unillustrated keyboard or the touch panel of the display 24 and sets, for the drawing-release date, a date that is within a desired range and comes before the above date as a new date (a candidate date). The desired range may be set in advance or, when lifting of the date restrictions is accepted, the date setting unit 18 may make the person set the number of months or days before and after the above date or an actual period. Then, the first assistance system 10A predicts the investment cost of a production facility.

Then, the lead time calculating unit (hereinafter written as a first lead time calculating unit 16A) of the first assistance system 10A calculates the lead time for the sum of the number of in-process items at the candidate date in the production facility manufacturing plant selected as an object of cost calculation and the number of production facilities to be manufactured this time. This calculation is performed based on the information from the scheduler 14, that is, the number of other production facilities in process that will remain at the candidate date and production facilities in process that is to be manufactured this time, the maximum number of production facilities that can be manufactured per unit period, and the number of production facilities to be manufactured this time. That is, the first lead time calculating unit 16A determines the lead time by dividing the sum of the above-described number of in-process items at the candidate date and the number of production facilities to be manufactured this time by the maximum number of production facilities that can be manufactured per unit period.

Moreover, the investment cost predicting unit (hereinafter “first investment cost predicting unit 20A”) of the first assistance system 10A includes, as depicted in FIG. 2, a plant information registering unit 26, a production facility number calculating unit 28, a production facility number updating unit 30, a plant information table TBa, and an investment cost information table TBb.

The plant information registering unit 26 registers, using yen as a reference and based on the foreign exchange rate in the above-mentioned database 12, the identification numbers of the plurality of production facility manufacturing plants in the plant information table TBa where the identification numbers are arranged in ascending order of production costs. That is, the identification number of the lowest-cost production facility manufacturing plant is registered at the top of the plant information table TBa. It goes without saying that the identification numbers can be registered in the plant information table TBa in an arbitrary order as long as the identification numbers can be referred to in ascending order of production costs. In the example above, the investment base currency has been yen but the investment base currency may be other currencies such as the dollar and the euro. This also applies to the following description.

The production facility number calculating unit 28 calculates the number of production facilities that the production facility manufacturing plant selected as an object of cost calculation can manufacture.

The production facility number updating unit 30 calculates the number of production facilities to be newly manufactured by subtracting the number of production facilities calculated by the production facility number calculating unit 28 from the initial number of production facilities to be manufactured.

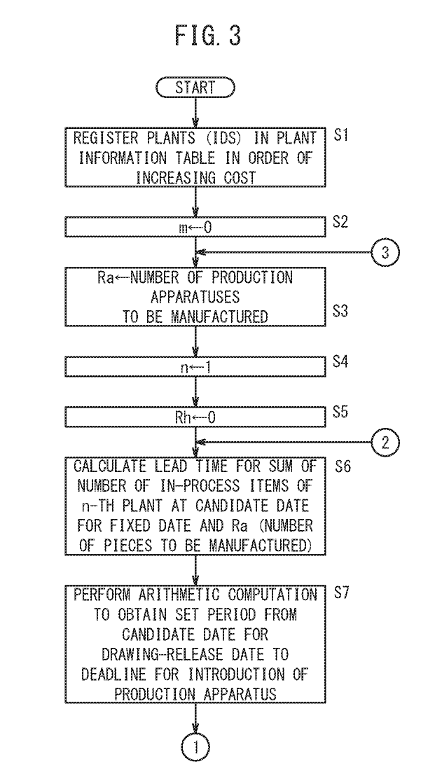

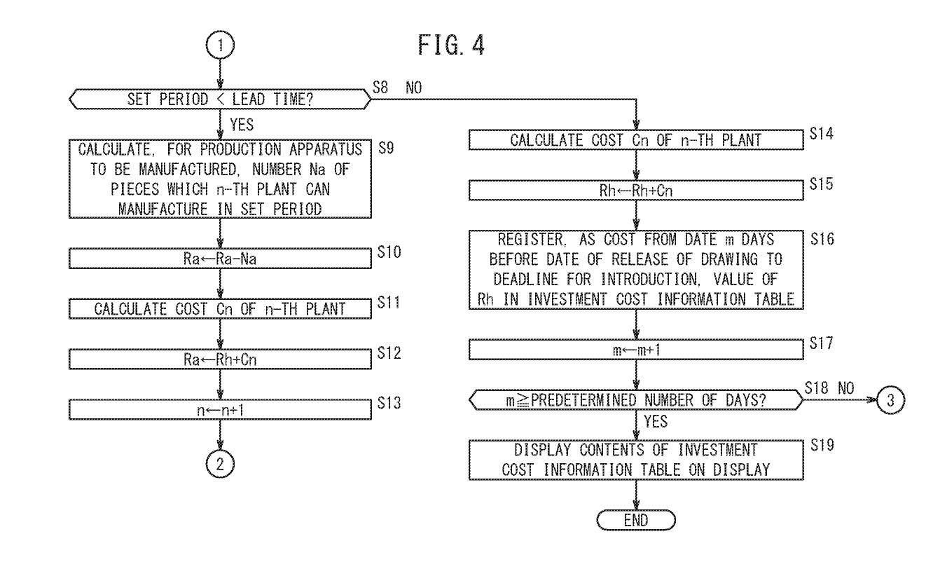

Next, a processing operation of the first assistance system 10A will be described with reference to flowcharts of FIGS. 3 and 4.

First, in Step S1 of FIG. 3, the plant information registering unit 26 registers the identification numbers of the plurality of production facility manufacturing plants in the plant information table TBa in ascending order of production costs.

In Step S2, the date setting unit 18 initializes a counter m for updating the number of days by storing an initial value (=0) in the counter m.

In Step S3, the first investment cost predicting unit 20A stores the number of production facilities to be manufactured this time in a register Ra for updating the number of pieces. The register Ra is used to update the number of pieces to be manufactured.

In Step S4, the first investment cost predicting unit 20A initializes a counter n for updating the plant by storing an initial value (=1) in the counter n.

In Step S5, the first investment cost predicting unit 20A initializes a cost addition register Rh by storing an initial value (=0) in the cost addition register Rh.

In Step S6, the first lead time calculating unit 16A calculates the lead time for the sum of the number of in-process items of an n-th plant at the candidate date (m days before the drawing-release date, which has been registered in the database 12) and the number of pieces to be manufactured that has been stored in the register Ra.

In Step S7, the first investment cost predicting unit 20A performs an arithmetic computation to obtain a set period from the candidate date to the deadline for introduction of the production facility.

In Step S8 of FIG. 4, a determination as to whether or not the set period is less than the lead time is made. If the set period is less than the lead time, the procedure proceeds to the next Step S9 and the first investment cost predicting unit 20A calculates, for the production facility to be manufactured, the number Na of pieces that the n-th plant can manufacture in the set period.

In Step S10, the first investment cost predicting unit 20A subtracts the number Na obtained in Step S9 from the number stored in the register Ra and stores the result again in the register Ra. That is, the first investment cost predicting unit 20A updates the number of pieces to be manufactured.

In Step S11, the first investment cost predicting unit 20A calculates a cost Cn of the n-th plant by multiplying the number of pieces that can be manufactured in the above-described set period by the unit cost of the n-th plant.

In Step S12, the first investment cost predicting unit 20A adds the cost Cn obtained in Step S11 to the cost up to the present stored in the cost addition register Rh and stores the result again in the cost addition register Rh.

In Step S13, the first investment cost predicting unit 20A updates the value of the counter n by incrementing the value by +1.

Then, the procedure return to Step S6 of FIG. 3, and the processes in and after Step S6 are repeated.

On the other hand, if a determination is made in the above-described Step S8 of FIG. 4 that the set period is more than or equal to the lead time, the procedure proceeds to Step S14 and the first investment cost predicting unit 20A calculates the cost Cn of the n-th plant by multiplying the number of pieces to be manufactured by the unit cost of the n-th plant.

In Step S15, the first investment cost predicting unit 20A adds the cost Cn obtained in Step S14 to the cost up to the present stored in the cost addition register Rh and stores the result again in the cost addition register Rh.

In Step S16, the first investment cost predicting unit 20A registers, as the cost from m days before the drawing-release date that has been registered in the database 12, up to the deadline for introduction of the production facility, the value of the cost addition register Rh in the investment cost information table TBb.

In Step S17, the date setting unit 18 updates the value of the counter m for by incrementing the value by +1.

In Step S18, the date setting unit 18 determines whether the value of the counter m is more than or equal to the predetermined number of days that has been set in advance. If the value of the counter m is less than the predetermined number of days that has been set in advance, the procedure goes back to the above-described Step S3 of FIG. 3 and the processes in and after Step S3 are repeated.

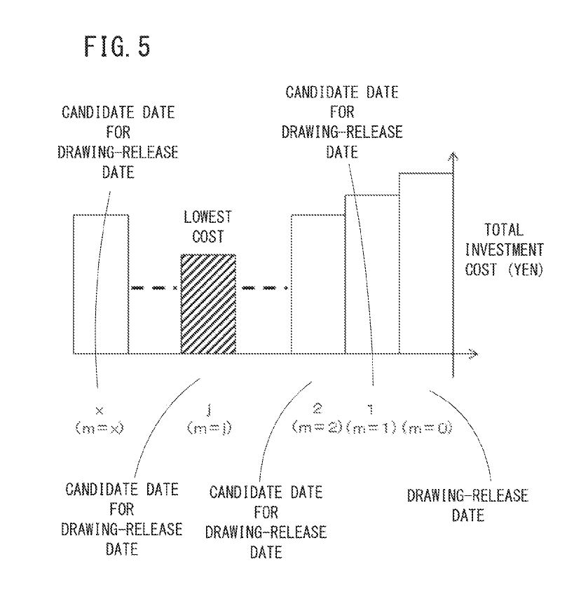

Then, in the above-described Step S18 of FIG. 4, if the value of the counter m is more than or equal to the predetermined number of days that has been set in advance, the procedure proceeds to the next Step S19 and the investment cost display control section 22 reads out the total investment cost registered in the investment cost information table TBb for each candidate date and displays the total investment cost on the display 24. Examples of a display mode include, as depicted in FIG. 5, performing display in the form of a bar graph, for example, with the candidate date being set on the horizontal axis and the total investment cost at each candidate date being set on the vertical axis, for instance. It is preferable to display the bar graph for the candidate date at which the total investment cost is the lowest, for example, in a different color. This makes it possible to recognize the candidate date, at which the cost is the lowest, and the investment cost with ease. Only the candidate date, at which the cost is the lowest, and the investment cost may be displayed.

This first assistance system 10A makes it possible to easily propose a schedule that can achieve the lowest cost by setting a date before the drawing-release date registered in the database 12 as a new drawing-release date by: for example, setting a date before the drawing-release date as a candidate date for release of a drawing; calculating the investment cost incurred from the candidate date ( ) to the deadline for introduction of the production facility; and setting the candidate date, at which the calculated investment cost is the lowest, as a new drawing-release date.

In the above-described example, the candidate date for the drawing-release date is set on a daily basis; in addition thereto, the candidate date for the drawing-release date may be set on a weekly or monthly basis. This makes it possible to find out quickly an approximate candidate for the drawing-release date at which the cost is the lowest.

Moreover, in the above-described example, for the drawing-release date, a date that is within a desired range and is before the drawing-release date is set as a new date (a candidate date); in addition thereto, a date that is within a desired range and is a date after the above date may be set as a new date (a candidate date).

Also in this case, as depicted in FIG. 5, the display 24 or the like may show a bar graph or the like with the candidate date being set on the horizontal axis and the total investment cost at each candidate date being set on the vertical axis.

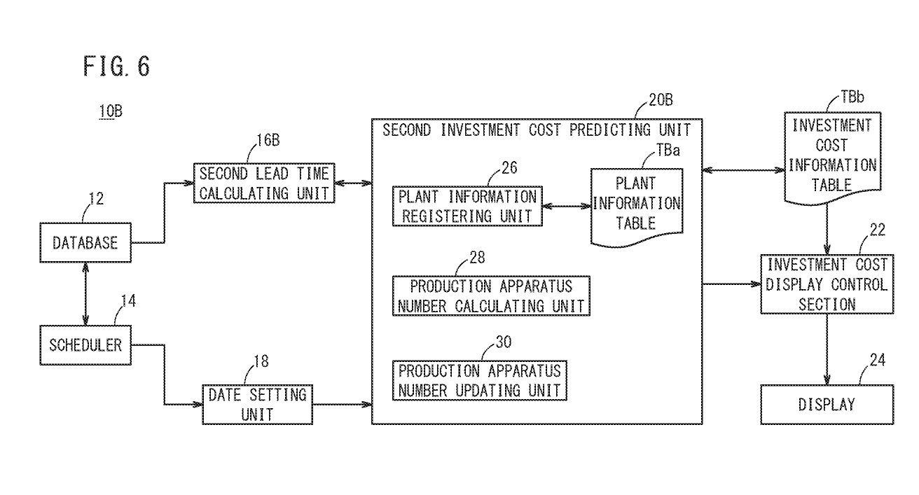

Next, the production facility investment planning assistance system (hereinafter written as a second assistance system 10B) according to a second specific example will be described with reference to FIGS. 6 to 9.

In this second assistance system 10B, the date setting unit 18 receives the input of lifting the date restrictions through, for instance, the input device such as an unillustrated keyboard or the touch panel of the display 24, lifts the date restrictions, and sets, as a new deadline for introduction of a production facility (a candidate date for a deadline), a date that is within a desired range and after the above deadline for introduction. The desired range may be set in advance or, the date setting unit 18 may receive an actual period or the number of months or days before or after the above deadline when accepting lifting of the date restrictions. Then, the second assistance system 10B predicts the investment cost of the production facility. That is, what is different from the first assistance system 10A described above is that a deadline for introduction of the production facility is set in place of a drawing-release date.

Then, as depicted in FIG. 6, the lead time calculating unit (hereinafter written as a second lead time calculating unit 16B) of the second assistance system 10B calculates, for the production facility manufacturing plant selected as an object of cost calculation, the lead time for the sum of the number of in-process items at the drawing-release date registered in the database 12 and the number of production facilities that will be manufactured this time. This calculation is performed based on the information from the scheduler 14, that is, the number of other production facilities in process at the drawing-release date, the maximum number of production facilities to be manufactured this time per unit period, and the number of production facilities to be manufactured this time. That is, the second lead time calculating unit 16B determines the lead time by dividing the sum of the above-described number of in-process items at the drawing-release date and the number of production facilities to be manufactured this time by the maximum number of production facilities to be manufactured this time per unit period.

Moreover, the investment cost predicting unit (hereinafter written as a second investment cost predicting unit 20B) of the second assistance system 10B includes, as depicted in FIG. 6, a plant information registering unit 26, a production facility number calculating unit 28, and a production facility number updating unit 30 that are similar to those of the first investment cost predicting unit 20A described above.

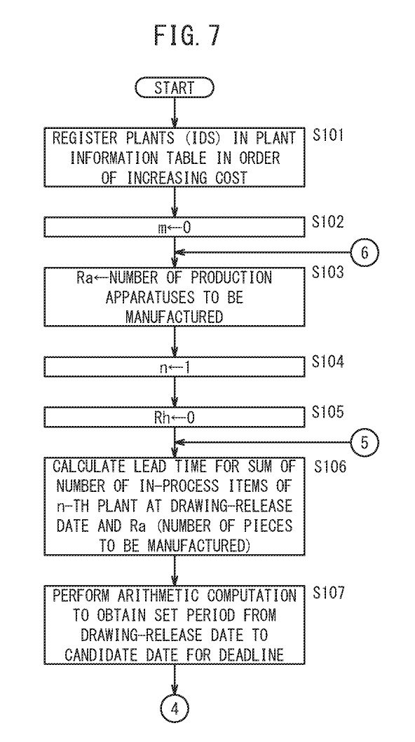

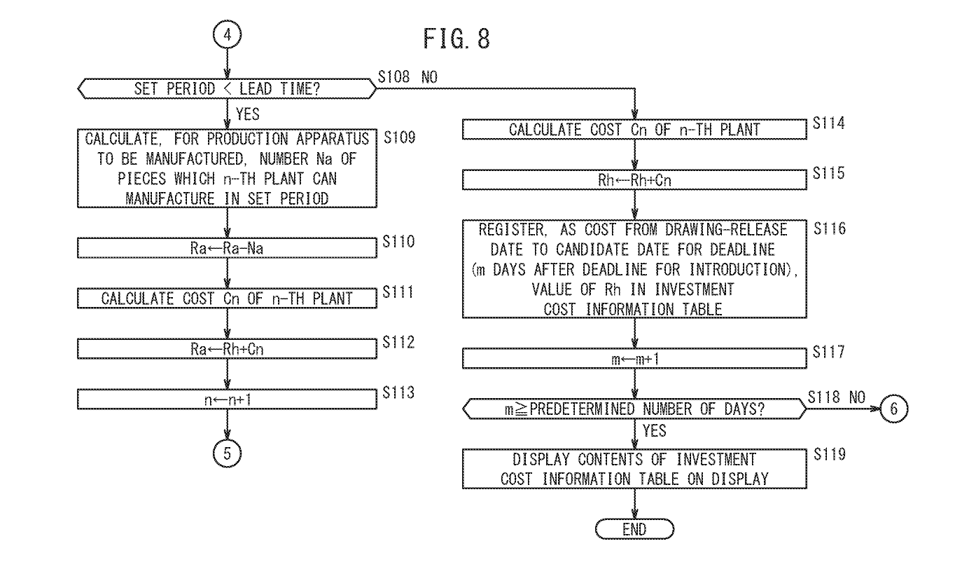

Next, a processing operation of the second assistance system 10B will be described with reference to flowcharts of FIGS. 7 and 8.

First, in Steps S101 to S105 of FIG. 7, processes similar to those (Steps S1 to S5) of the above-described first assistance system 10A are performed and therefore overlapping explanations thereof will be omitted.

In Step S106, the second lead time calculating unit 16B calculates the lead time for the sum of the number of in-process items of an n-th plant at the drawing-release date and the number of pieces to be manufactured that is stored in the register Ra.

In Step S107, the second investment cost predicting unit 20B calculates a set period from the drawing-release date to a candidate date for a deadline (m days after the deadline for introduction registered in the database 12).

In Step S108 of FIG. 8, the second investment cost predicting unit 20B determines whether or not the set period from the drawing-release date to the candidate date for a deadline is less than the lead time. If the set period is less than the lead time, the procedure proceeds to the next Step S109 and the second investment cost predicting unit 20B calculates, among the total number of pieces to be manufactured, the number Na of pieces that the n-th plant can manufacture during the set period.

In Step S110, the second investment cost predicting unit 20B subtracts the number Na obtained in Step S109 from the number that has been stored in the register Ra and stores the result in the register Ra. That is, the second investment cost predicting unit 20B updates the number of pieces that should be manufactured.

In Step S111, the second investment cost predicting unit 20B calculates a cost Cn of the n-th plant by multiplying the number of pieces that can be manufactured during the above-described set period by the unit cost of the n-th plant.

In the Step S112, the second investment cost predicting unit 20B adds the cost obtained in Step S111 to the cost up to the present stage which is stored in the cost addition register Rh, and stores the result in the cost addition register Rh.

In Step S113, the second investment cost predicting unit 20B updates the value of the counter n for updating the plant by incrementing the value of the counter n by +1.

Then, the procedure returns to Step S106 of FIG. 7 and the processes in and after Step S106 are repeated.

On the other hand, if a determination is made in the above-described Step S108 of FIG. 8 that the set period is more than or equal to the lead time, the procedure proceeds to Step S114 and the second investment cost predicting unit 20B calculates the cost Cn of the n-th plant by multiplying the number of pieces to be manufactured by the unit cost of the n-th plant.

In Step S115, the second investment cost predicting unit 20B adds the cost Cn obtained in Step S114 to the cost up to the present stage which is stored in the cost addition register Rh, and stores the result in the cost addition register Rh.

In Step S116, the second investment cost predicting unit 20B registers, as the cost from the drawing-release date registered in the database 12 up to the candidate date for a deadline (m days after the deadline for introduction), the value of the cost addition register Rh in the investment cost information table TBb.

In Step S117, the date setting unit 18 updates the value of the counter m by incrementing the value of the counter m by +1.

In Step S118, the date setting unit 18 determines whether the value of the counter m is more than or equal to the predetermined number of days which is set in advance. If the value of the counter m is less than the predetermined number of days which is set in advance, the procedure returns to Step S103 and the processes in and after Step S103 are repeated.

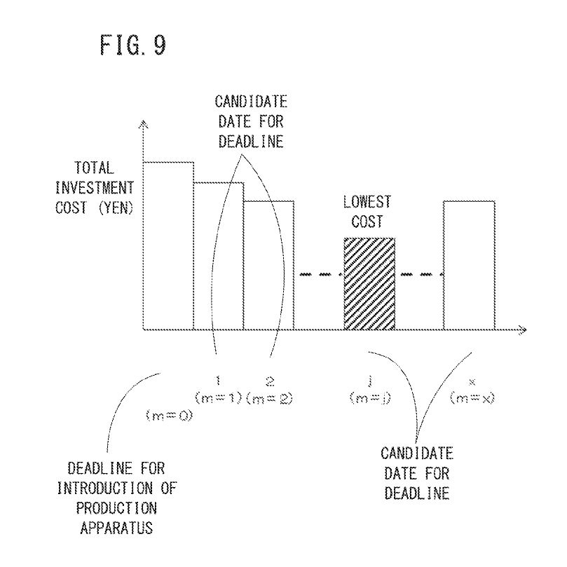

Then, if the value of the counter m is more than or equal to the predetermined number of days which is set in advance, the procedure proceeds to the next Step S119 and the investment cost display control section 22 reads out the total investment cost registered in the investment cost information table TBb for each candidate date for a deadline and displays the total investment cost on the display 24. Examples of a display mode include, as depicted in FIG. 9, performing display in the form of a bar graph, for example, with the candidate date for a deadline being set on the horizontal axis and the total investment cost at each candidate date for a deadline being set on the vertical axis, for instance. Also in this case, it is preferable to color a bar that corresponds to the lowest total investment cost, differently from the other bars. This makes it possible to recognize the candidate date for a deadline at which the cost is the lowest as well as the investment cost with ease. Only the candidate date for a deadline at which the cost is the lowest and the investment cost may be displayed.

This second assistance system 10B sets a date after the deadline for introduction of the production facility as a candidate date for a new deadline for introduction (a candidate date for a deadline), calculates the investment cost during a period from the drawing-release date to the candidate date for a deadline, and sets the candidate date for a deadline at which the calculated investment cost is the lowest, as a new deadline for introduction of the production facility. In this way, the second assistance system 10B produces the effect of easily proposing a schedule that can achieve the lowest cost with a new deadline being a date after the deadline for introduction of the production facility that has been registered in the database 12.

In the above-described example, the candidate date for the deadline for introduction is set on a daily basis; in addition thereto, the candidate date for the deadline for introduction may be set on a weekly or monthly basis. This makes it possible to find out quickly an approximate candidate for the deadline for introduction at which the cost is the lowest.

Moreover, in the above-described example, for the deadline for introduction of the production facility, a date which is within a desired range and after the above deadline is set as a new deadline (a candidate date for a deadline); in addition thereto, a date which is within a desired range and is a date before the deadline for introduction may be set as a new deadline for introduction (a candidate date for a deadline).

Also in this case, as depicted in FIG. 9, a bar graph may be displayed where the candidate date for a deadline is set on the horizontal axis and the total investment cost at each candidate date for a deadline is set on the vertical axis.

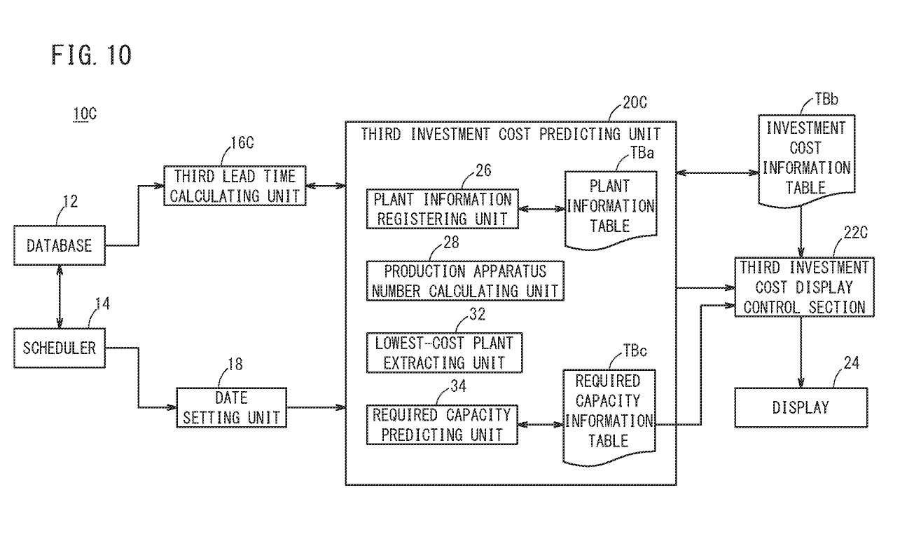

Next, the production facility investment planning assistance system (hereinafter written as a third assistance system 10C) according to a third specific example will be described with reference to FIGS. 10 to 13B.

In this third assistance system 10C, the date setting unit 18 lifts the date restrictions by making a person input lifting of the date restrictions through, for instance, the input device such as an unillustrated keyboard or the touch panel of the display 24 and sets, as a new drawing-release date (a candidate date) regarding the lowest-cost plant, a date that is within a desired range and is a date before the above date as a new date. The desired range may be set in advance or, when accepting lifting of the date restrictions, the date setting unit 18 may make the person set, as the desired range, the number of months or days before and after the above date or an actual period. Furthermore, the third assistance system 10C predicts the investment cost of the production facility by distributing the total actions necessary for manufacturing a production facility, that is, lifting restrictions on capacity.

Then, as depicted in FIG. 10, the lead time calculating unit (hereinafter a “third lead time calculating unit 16C”) of the third assistance system 10C calculates the lead time for the sum of the number of in-process items at the candidate date in the lowest-cost production facility manufacturing plant selected as an object of cost calculation and the number of production facilities to be manufactured this time. This calculation is performed based on the information from the scheduler 14; that is, the number of other production facilities that is in process at the candidate date, the maximum number of production facilities to be manufactured per unit period, and the number of production facilities to be manufactured this time. That is, the third lead time calculating unit 16C determines the lead time by dividing the sum of the above-described number of in-process items at the candidate date and the number of production facilities to be manufactured this time by the maximum number of production facilities to be manufactured per unit period.

Moreover, the investment cost predicting unit (hereinafter a “third investment cost predicting unit 20C”) of the third assistance system 10C includes, as depicted in FIG. 10, a plant information registering unit 26, a lowest-cost plant extracting unit 32, a production facility number calculating unit 28, a required capacity predicting unit 34, a plant information table TBa, an investment cost information table TBb, and a required capacity information table TBc.

The lowest-cost plant extracting unit 32 extracts the lowest-cost production facility manufacturing plant from among a plurality of registered production facility manufacturing plants; for example, the lowest-cost plant extracting unit 32 extracts an identification number thereof.

The production facility number calculating unit 28 calculates the number of production facilities that the lowest-cost production facility manufacturing plant extracted as an object of cost calculation can manufacture.

The required capacity predicting unit 34 predicts, with respect to the lowest-cost plant, capacity (for example, the number of pieces manufactured per day) required to make the set period from the candidate date to the deadline for introduction equal to the lead time and registers the capacity in the required capacity information table TBc.

The investment cost display control section (hereinafter a “third investment cost display control section 22C”) of the third assistance system 10C displays, for example, the investment cost and the required capacity predicted for each new date on the display 24.

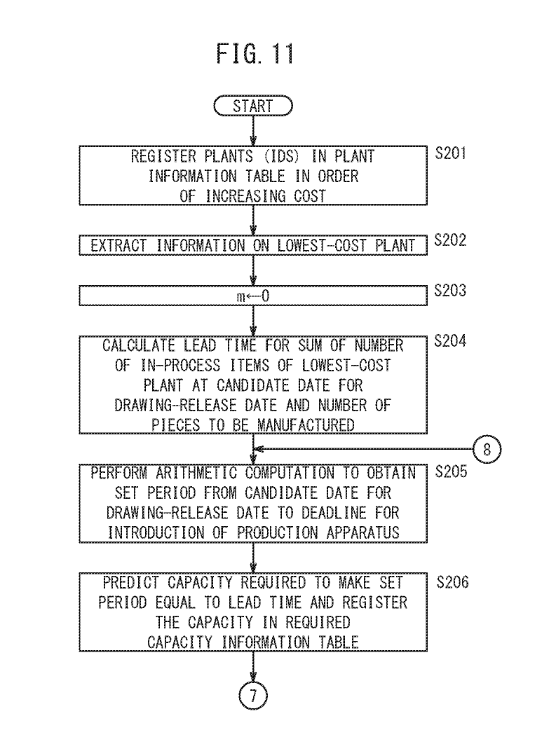

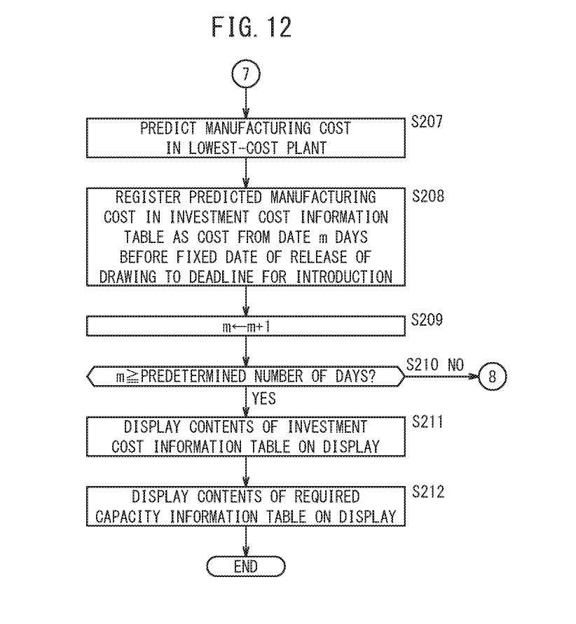

Next, a processing operation of the third assistance system 10C will be described with reference to flowcharts FIGS. 11 and 12.

First, in Step S201 of FIG. 11, the plant information registering unit 26 registers, by using yen as a reference based on the foreign exchange rate in the database 12, the identification numbers or the like of the plurality of production facility manufacturing plants in the plant information table TBa in ascending order of production cost.

In Step S202, the lowest-cost plant extracting unit 32 extracts the information (such as the identification number) on the lowest-cost plant from the head of the plant information table TBa.

In Step S203, the date setting unit 18 initializes the counter m by storing an initial value (=0) in the counter m.

In Step S204, the third lead time calculating unit 16C calculates the lead time for the sum of the number of in-process items in the lowest-cost plant at a candidate date (m days before the drawing-release date that is registered in the database 12) and the number of pieces to be manufactured this time.

In Step S205, the third investment cost predicting unit 20C calculates a set period between the candidate date and the deadline for introduction of the production facility.

In Step S206, the required capacity predicting unit 34 predicts capacity (for example, the number of pieces manufactured per day) required to make the set period equal to the above-described lead time and registers the capacity in the required capacity information table TBc.

In Step S207 of FIG. 12, the third investment cost predicting unit 20C predicts the manufacturing cost in the lowest-cost plant by multiplying the number of pieces to be manufactured by the unit cost at the lowest-cost plant.

In Step S208, the third investment cost predicting unit 20C registers the predicted manufacturing cost in the investment cost information table TBb as the cost during a period from m days before the drawing-release date that is registered in the database 12, to the deadline for introduction of the production facility.

In Step S209, the date setting unit 18 updates the value of the counter m by incrementing the value of the counter m by +1.

In Step S210, the date setting unit 18 determines whether the value of the counter m is more than or equal to the predetermined number of days that is set in advance. If the value of the counter m is less than the predetermined number of days that is set in advance, the procedure returns to Step S205 of FIG. 11 and the processes in and after Step S205 are repeated.

Then, in the above-described Step S210 of FIG. 12, if the value of the counter m is more than or equal to the predetermined number of days that is set in advance, the procedure proceeds to the next Step S211 and the third investment cost display control section 22C reads out the total investment cost registered in the investment cost information table TBb for each candidate date and displays the total investment cost on the display 24. Moreover, in Step S212, the third investment cost display control section 22C reads out the required capacity registered in the required capacity information table TBc for each candidate date and displays the required capacity on the display 24.

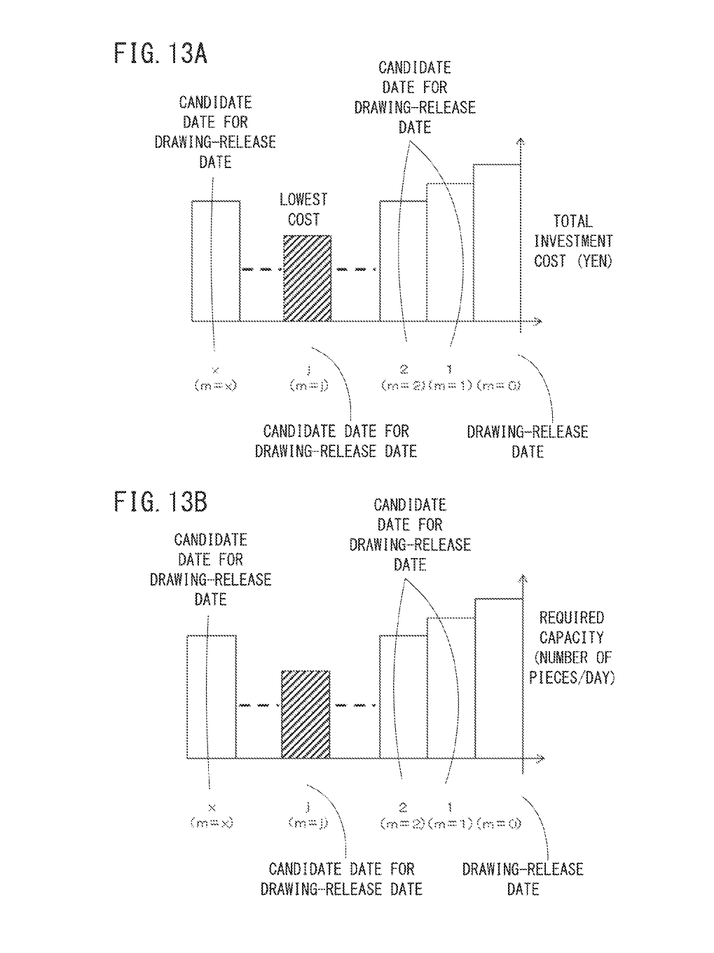

Examples of a display mode include both a first graph depicted in the form of a bar graph as shown in FIG. 13A with the candidate date being set on the horizontal axis and the total investment cost at each candidate date being set on the vertical axis and a second graph depicted in the form of a bar graph as shown in FIG. 13B with the candidate date being set on the horizontal axis and the required capacity for each candidate date being set on the vertical axis. It is preferable to color bar graphs differently for the following modes:

(1) A bar graph showing the lowest total investment cost;

(2) A bar graph showing the lowest required capacity;

(3) A bar graph showing the lowest total investment cost and the lowest required capacity.

This makes it easy to recognize the candidate date at which the cost is the lowest, the investment cost, and the required capacity. In addition thereto, it also becomes possible to make a proposal in regard to sufficient capacity for future manufacturing in the lowest-cost plant.

Moreover, in the above-described example, a date that is within a desired range and is a date before the above date is set as a new drawing-release date (a candidate date). In addition thereto, a date that is within a desired range and is a date after the above date may be set as a new date (a candidate date).

Also in this case, as depicted in FIGS. 13A and 13B, examples include a bar graph with the candidate date being set on the horizontal axis and the total investment cost at each candidate date being set on the vertical axis together with the required capacity for each candidate date.

### Modified Examples

In the database 12, a country that produces a product or a component (a country of production where a production facility is used) and a country that manufacture the production facility for producing (manufacturing) the product or the component (a country of manufacture) may be registered. In this case, the investment cost display control section 22 may display the predicted investment cost in terms of the currencies of the country of production and the country of manufacture (in terms of yen, dollar, yuan, euro, peso, and so forth). This makes it possible to coordinate schedules or the like smoothly with a person in charge in a country that enjoys investment.

In the database 12, in addition to domestic factories, foreign factories may be included. In this case, it is preferable to register also a country code indicating a country where each factory is located. Including the country code in the database 12 makes it easy to reflect the cost of transportation between the country where each factory is located and a customer (a country of production), the number of days required for the transportation, the local currency of the country where each factory is located, fluctuations in the foreign exchange rate, and so forth in the investment cost.

Moreover, it is preferable to register unit necessary actions for manufacturing a production facility for each of a plurality of products or components, unit cost, a manufacturing time required for a production facility (unit lead time), and so forth in the database 12.

It is preferable to register in the database 12, for each plant, internal production (internal manufacturing) or external production (external manufacturing), the name of an entity (the name of a company) in the case of the external production, the unit number of necessary actions at the entity, the unit cost, and the manufacturing time per one production facility (the unit lead time) and so forth.

It is preferable to register in the database 12, for each plant, the unit cost of transportation (the unit cost and customs) between a country of production of a product or a part (a workpiece) and a country where the plant is located, the number of days required for transportation, and so forth about a production facility. This makes it easy to reflect, for each plant, the cost of transportation between a country where the plant is located and a customer (a country of production), the number of days required for transportation, the local currency of the country where the plant is located, fluctuations in the foreign exchange rate, and so forth in the investment cost.

Moreover, it is preferable to register in the database 12, for each plant, the maximum number (the capacity) of production facilities that can be manufactured per unit time (per month, for example). The maximum number (the capacity) of production facilities that can be manufactured may be obtained from the scheduler 14 installed in each plant; however, registering the above-described information in the database 12 makes it possible to gather the source of information in the database 12 and thereby implement rapid information processing.

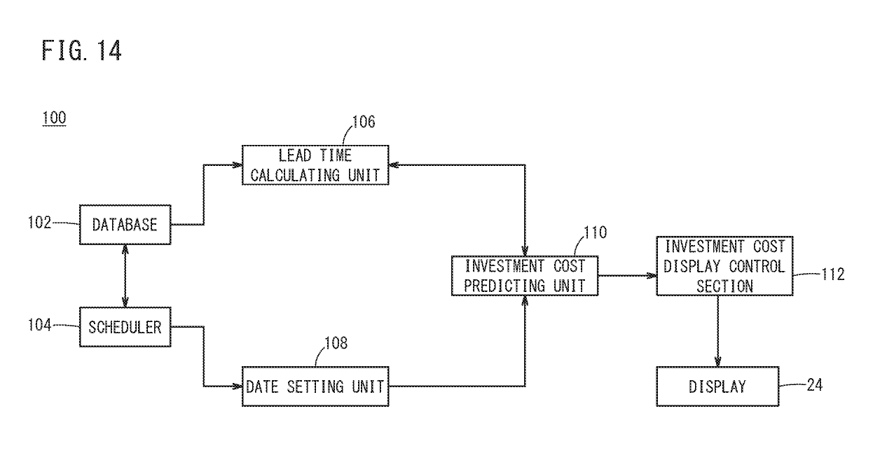

Next, an embodiment example of a commodity production system 100 that performs production planning of a commodity will be described with reference to FIG. 14.

As depicted in FIG. 14, the commodity production system 100 according to the present embodiment has almost the same configuration as the above-described production facility investment planning assistance system 10 and includes a database 102, a scheduler 104, a lead time calculating unit 106, a date setting unit 108, an investment cost predicting unit 110, and an investment cost display control section 112.

In the database 102, various kinds of data are registered via a network or through an input device such as a keyboard. In particular, date restrictions including a scheduled date of confirmation of order specifications of a commodity and a date of delivery of the commodity are registered therein.

In addition to the above-described data, various kinds of data about a plurality of commodity manufacturing plants are registered in the database 102. Examples of the various kinds of data include the following (d) to (f):

(d) The cost of transportation (including customs) between a country where each commodity manufacturing plant is located and a country where a customer (such as a sales outlet for the commodity) is located;

(e) The number of days required for transportation;

(f) Fluctuations in the foreign exchange rate (rate: unit local currency=xxx yen) of local currency to Japanese yen, for example, if the country where the commodity manufacturing plant is located is not Japan

As mentioned earlier, (f) may be updated at predetermined time intervals or may be set at a predicted rate based on the fluctuations in the past several months, for example. The average rate of the past several months may be adopted instead.

In some cases, the scheduler 104 is installed in each of the plurality of commodity manufacturing plants that manufacture commodities, or is installed in a country that serves as a hub of the countries where these commodity manufacturing plants are located and transmits a schedule to the plurality of commodity manufacturing plants via the network. In particular, this scheduler 104 performs scheduling with consideration given to at least the date restrictions and in-process commodities at the plurality of commodity manufacturing plants that manufacture the commodities, the maximum number of commodities that can be manufactured per unit period and the unit cost (cost divided by the number of pieces) of the commodity in each commodity manufacturing plant, and the like. If the scheduler 104 is installed in each of the plurality of commodity manufacturing plants, the above-described in-process commodities, maximum number of commodities that can be manufactured per unit period, and the like are registered in the database 102 via the network.

The lead time calculating unit 106 calculates at least a necessary lead time from a plurality of pieces of data (such as the maximum number of commodities that can be manufactured per unit period) related to the plurality of commodity manufacturing plants. In addition to the lead time, the lead time calculating unit 106 may calculate the number of actions.

The date setting unit 108 accepts lifting of the date restrictions through, for example, an input device such as an unillustrated keyboard or a touch panel of a display 24, lifts at least the date restrictions, and sets, for at least one of the scheduled date of confirmation of order specifications and the date of delivery of the commodity, a date that is within a desired range and is a date before or after the above date as a new date.

The investment cost predicting unit 110 predicts the investment cost of the commodity based on the new date thus set.

The investment cost display control section 112 displays, for example, the investment cost predicted for each of the new dates on the display 24.

This makes it possible to propose a schedule that can minimize the investment cost of the commodity.

In particular, since the drawing-release date and the deadline for introduction of the production facility in the production facility investment planning assistance system 10 correspond to the scheduled date of confirmation of order specifications and the date of delivery of the commodity, any one of the above-described first to third assistance systems 10A to 10C can also be applied to this commodity production system 100, which makes it possible to obtain the effects similar to those of the first to third assistance systems 10A to 10C.

It is understood that the production facility investment planning assistance system and the commodity production system according to the present invention are not limited to the above-described embodiments and can adopt various configurations within the scope of the present invention.

What is claim is:

1. A production facility investment planning assistance system that assists planning and drafting of an investment cost of a production facility that is used for producing a future product or a component thereof, the production facility investment planning assistance system comprising:
a database to which date restrictions including at least a date of release of a drawing of the product or the component thereof and a deadline for introduction of the production facility and a date of start of mass production of the product and the component thereof are input;
a unit that gives consideration to at least the date restrictions, and in-process production facilities at a plurality of production facility manufacturing plants that manufacture the production facility and a maximum number of production facilities that can be manufactured per unit period in each production facility manufacturing plant;
a unit that calculates at least a necessary lead time from a plurality of pieces of data related to the plurality of production facility manufacturing plants;
a unit that lifts at least the date restrictions and sets, for at least one of the date of release of a drawing and the deadline for introduction of the production facility, a date that is within a desired range and is a date before or after the above date as a new date; and
a unit that predicts an investment cost of the production facility based on at least the new date thus set.

2. The production facility investment planning assistance system according to claim 1, comprising:
a display that displays the investment cost of the production facility.

3. The production facility investment planning assistance system according to claim 2, wherein
the production facility investment planning assistance system stops giving consideration to the maximum number of production facilities that can be manufactured in each production facility manufacturing plant while lifting the date restrictions, and predicts the investment cost of the production facility by allotting a total number of actions necessary for the production facility to a production facility manufacturing plant that can manufacture the production facility at a lowest cost among the plurality of production facility manufacturing plants.

4. The production facility investment planning assistance system according to claim 2, wherein
the production facility investment planning assistance system displays a lowest investment cost when predicting the investment cost of the production facility.

5. The production facility investment planning assistance system according to claim 3, wherein
the production facility investment planning assistance system displays the lowest required capacity when predicting the investment cost of the production facility.

6. The production facility investment planning assistance system according to claim 5, wherein
the lowest required capacity is displayed using a graph with different colors.

7. The production facility investment planning assistance system according to claim 3, wherein
the production facility investment planning assistance system displays the lowest investment cost and the lowest required capacity when predicting the investment cost of the production facility.

8. The production facility investment planning assistance system according to claim 7, wherein
the lowest investment cost and the lowest required capacity is displayed using a graph with different colors.

9. The production facility investment planning assistance system according to claim 1, wherein
the production facility investment planning assistance system displays at least the predicted investment cost in local currency of an investing country.

10. The production facility investment planning assistance system according to claim 1, wherein
the plurality of pieces of data on the production facility manufacturing plants include a number of days required for transportation and a cost of transportation between a country where each production facility manufacturing plant is located and a country where a customer that uses the production facility is located, and
the unit of calculating the lead time calculates the necessary lead time including the cost of transportation and the number of days required for transportation.

11. The production facility investment planning assistance system according to claim 1, wherein
the plurality of pieces of data on the production facility manufacturing plants include a country where each production facility manufacturing plant is located and an exchange rate of a local currency of the country to an investment base currency, and
the unit of predicting the investment cost of the production facility predicts the investment cost of the production facility including the exchange rate.

12. A commodity production system that performs production planning of a commodity, the commodity production system comprising:
a database to which date restrictions including at least a scheduled date of confirmation of order specifications of the commodity and a date of delivery of the commodity are input;
a unit that gives consideration to at least the date restrictions, goods in process and an inventory of the commodity in each of a plurality of production bases that produce the commodity, and a maximum number of commodities that can be produced per unit period in each production base;
a unit that calculates at least a number of actions and a necessary lead time from a plurality of pieces of data related to the production bases;
a unit that lifts at least the date restrictions and setting, for at least one of the scheduled date of confirmation of order specifications and the date of delivery, a date that is within a desired range and is a date before or after the above date as a new date; and
a unit that predicts a production cost of the commodity based on at least the new date thus set.
